(19) United States
(12) Patent Application Publication
(10) Pub. No.: US 2025/0306218 A1
(43) Pub. Date: Oct. 2, 2025

(54) INFORMATION PROCESSING DEVICE AND INFORMATION PROCESSING METHOD

(71) Applicant: TOYOTA JIDOSHA KABUSHIKI KAISHA, Toyota-shi (JP)

(72) Inventors: Hirokazu INAYOSHI, Toyota-shi (JP); Masanari IMADA, Toyota-shi (JP)

(73) Assignee: TOYOTA JIDOSHA KABUSHIKI KAISHA, Toyota-shi (JP)

(21) Appl. No.: 19/086,309

(22) Filed: Mar. 21, 2025

(30) Foreign Application Priority Data
Mar. 29, 2024 (JP) 2024-056688

(51) Int. Cl. G01S 19/48

(52) U.S. Cl. CPC G01S 19/48

(57) ABSTRACT

The information processing device according to the present disclosure is an information processing device that localizes a vehicle, and includes a control unit configured to: receive a GNSS signal; acquire information indicating a traveling state of the vehicle; and determine whether to localize the vehicle based on the GNSS signal or to localize the vehicle based on the information indicating the traveling state of the vehicle, based on whether a first location and a second location match, the first location being a location of the vehicle estimated from previously acquired location information of the vehicle and the information indicating the traveling state of the vehicle, and the second location being a location of the vehicle calculated based on the GNSS signal.

### CROSS-REFERENCE TO RELATED APPLICATION

This application claims priority to Japanese Patent Application No. 2024-056688 filed on Mar. 29, 2024, incorporated herein by reference in its entirety.

### BACKGROUND

### 1. Technical Field

The present disclosure relates to vehicle localization.

### 2. Description of Related Art

There are many known vehicle localization techniques. In this regard, for example, Japanese Unexamined Patent Application Publication No. 2018-60436 (JP 2018-60436 A) discloses an in-vehicle device etc. that, when the in-vehicle device is unable to acquire a global positioning system (GPS) signal, identifies a traveling location of a vehicle based on a weight associated with the last checkpoint the vehicle passed, a vehicle speed, and an elapsed time since the time point the in-vehicle device last acquired a GPS signal.

### SUMMARY

It is an object of the present disclosure to accurately localize a vehicle even when reliability of a received global navigation satellite system (GNSS) signal is not high.

One aspect of an embodiment of the present disclosure is an information processing device.

The information processing device includes a control unit.
The control unit is configured to
localize a vehicle,
receive a GNSS signal,
acquire information indicating a traveling state of the vehicle, and
determine whether to localize the vehicle based on the GNSS signal or to localize the vehicle based on the information indicating the traveling state of the vehicle, based on whether a first location and a second location match. The first location is a location of the vehicle estimated from previously acquired location information of the vehicle and the information indicating the traveling state of the vehicle. The second location is a location of the vehicle calculated based on the GNSS signal.

One aspect of an embodiment of the present disclosure is an information processing method.

The information processing method includes:
localizing a vehicle;
receiving a GNSS signal;
acquiring information indicating a traveling state of the vehicle; and
determining whether to localize the vehicle based on the GNSS signal or to localize the vehicle based on the information indicating the traveling state of the vehicle, based on whether a first location and a second location match. The first location is a location of the vehicle estimated from previously acquired location information of the vehicle and the information indicating the traveling state of the vehicle. The second location is a location of the vehicle calculated based on the GNSS signal.

Other aspects include the above method, a program for causing a computer to perform the method, and a computer-readable storage medium storing the program in a non-transitory manner.

According to the present disclosure, it is possible to accurately localize the vehicle even when the reliability of the received GNSS signal is not high.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1A shows an example of a process that is performed by an in-vehicle device according to an embodiment;

FIG. 1B shows an example of the process that is performed by the in-vehicle device according to the embodiment;

FIG. 2 illustrates components of the in-vehicle device according to the embodiment; and

FIG. 3 is a flowchart of a process that is performed by a control unit of the in-vehicle device according to the embodiment.

### DETAILED DESCRIPTION OF EMBODIMENTS

There is known a system for localizing a traveling host vehicle.

For example, a method for localizing a vehicle based on a GNSS received during traveling will be described. First, a vehicle receives a GNSS signal from satellites. Then, the location (hereinafter, referred to as a positioning location) calculated based on GNSS received by the vehicle is estimated as the location of the vehicle. When the vehicle is unable to receive GNSS signal for some reason while the vehicle is traveling, the system updates the location information last acquired by the vehicle by using the information (velocity, traveling direction, and the like) acquired via the in-vehicle sensor. This allows the system to estimate the most recent location of the vehicle.

However, the reliability of GNSS received by the vehicles is not always high. For example, it may be assumed that the location calculated based on GNSS received by the vehicle differs significantly from the actual location of the vehicle. As such a case, a case in which a positioning error temporarily increases due to an external factor, or a case in which a false GNSS signal is transmitted to a vehicle for attacking may be considered. In such a case, if the positioning location is always treated as correct, the vehicle cannot be accurately localized, which may cause inconvenience.

In order to cope with such a problem, it is preferable that the system determines the high reliability of GNSS signal received by the vehicle, and localize the vehicle as the positioning location only when the reliability of GNSS signal is high.

An information processing device according to the one aspect of the present disclosure includes a control unit configured to:

An information processing device that localizes a vehicle includes a control unit configured to: receive a GNSS signal; acquire information indicating a traveling state of the vehicle; determine whether to localize the vehicle based on the GNSS signal or to localize the vehicle based on the information indicating the traveling state of the vehicle, based on whether a first location and a second location match. The first location is a location of the vehicle estimated from previously acquired location information of the vehicle and the information indicating the traveling state of the vehicle. The second location is a location of the vehicle calculated based on the GNSS signal.

GNSS signal is a signal for satellite positioning transmitted from a satellite such as a GPS satellite or a quasi-zenith satellite. GNSS may be transmitted from a plurality of satellites.

The information indicating the traveling state of the vehicle is information including a vehicle speed of the vehicle, a traveling direction of the vehicle, time information, and the like. The information indicating the traveling state of the vehicle is hereinafter also referred to as traveling information.

The first location is a location of the vehicle estimated by adding a difference calculated based on the information indicating the traveling state (travel information) to a location of the vehicle acquired in advance. The first location may be a location of the vehicle at a second time that is estimated by adding a difference calculated based on the travel information obtained up to the second time after the first time to the location of the vehicle acquired at a first time.

The second location is a location of the vehicle calculated based on GNSS received at the second time.

The control unit determines whether to localize the vehicle based on the GNSS signal received at the second time or to localize the vehicle based on the travel information (i.e., using the difference), depending on whether the first location and the second location match.

For example, when the first location and the second location match, the GNSS signal received at the second time is likely to be reliable. In this case, it is preferable to localize the vehicle based on the acquired GNSS signal.
Conversely, when the first location and the second location do not match, the GNSS signal received at the second time may be unreliable. In this case, it is preferable to localize the vehicle based on the location information acquired previously (at the first time) and the travel information, instead of the GNSS signal received at the second time.

Accordingly, the information processing device according to the present disclosure can accurately localize the vehicle even when the reliability of the GNSS signal received by the vehicle is not high.

The control unit may be configured to localize the vehicle based on the GNSS signal when a difference between the first location and the second location is within a predetermined range.

When the difference between the first location and the second location is within the predetermined range, it is possible to estimate that the received GNSS signal is highly reliable, and therefore it is preferable to localize the vehicle using the GNSS signal.

The control unit may localize the vehicle based on the information indicating the traveling state of the vehicle when it is determined that the vehicle is traveling and it is determined that the location of the vehicle calculated based on the GNSS signal has not changed.

This is because, when the location of the vehicle calculated based on GNSS signal does not change even though the vehicle is in the traveling state, the reliability of GNSS signal is considered to be low. In such a case, it is preferable to localize the vehicle based on the travel information of the vehicle (that is, localize the vehicle by the difference).

Further, the control unit need not localize the vehicle when it is determined that the vehicle is not in the traveling state and it is determined that the location of the vehicle calculated based on the GNSS signal has not changed.

In such a case, since it can be estimated that the vehicle is at a stop, it is possible to choose not to perform localization.

An information processing method according to an aspect of the present disclosure includes: receiving a GNSS signal; acquiring information indicating a traveling state of the vehicle; and determining whether to localize the vehicle based on the GNSS signal or to localize the vehicle based on the information indicating the traveling state of the vehicle, based on whether a first location and a second location match. The first location is a location of the vehicle estimated from previously acquired location information of the vehicle and the information indicating the traveling state of the vehicle. The second location is a location of the vehicle calculated based on the GNSS signal.

Hereinafter, embodiments of the present disclosure will be described with reference to the drawings. A hardware configuration, a module configuration, a functional configuration, etc., described in each embodiment are not intended to limit the technical scope of the disclosure to them only unless otherwise stated.

### Embodiment

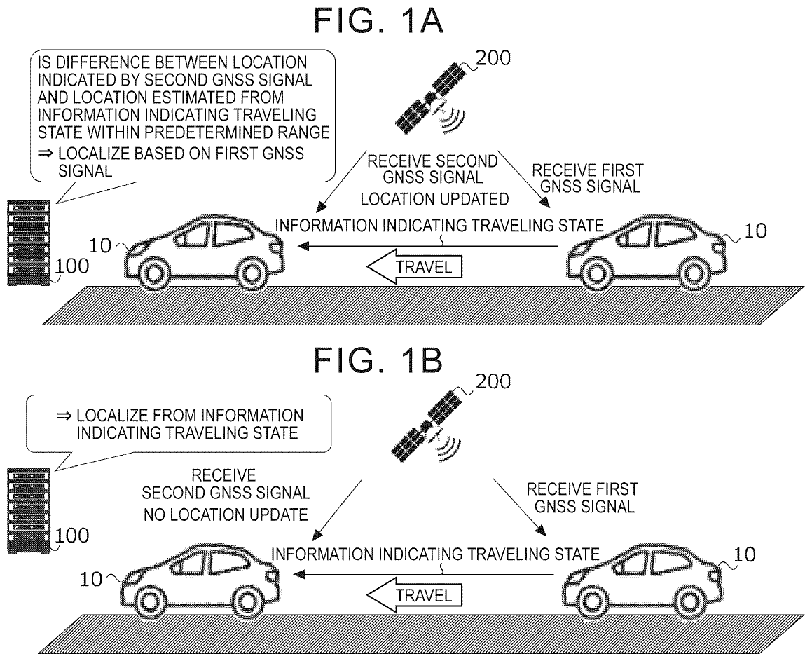

An outline of processing performed by the in-vehicle device according to the embodiment will be described with reference to FIG. 1. FIG. 1 is a diagram illustrating an example of processing executed by the in-vehicle device 100 according to the embodiment. Here, the in-vehicle device 100 is an example of an information processing device according to the present disclosure. The in-vehicle device 100 is a device that acquires a GNSS signal, a beacon signal, information on a traveling state of the vehicle (hereinafter, travel information), etc. and localizes the vehicle 10. The in-vehicle device 100 is configured to be capable of communicating with the vehicle 10. Vehicle 10 includes a module that receives signals from satellites 200 and receives GNSS signals from satellites 200. The in-vehicle device 100 may acquire GNSS received by the vehicle 10 from the vehicle 10.

First, the vehicles 10 receive GNSS signals transmitted from the satellites 200. It is assumed that the vehicles 10 periodically receive GNSS from satellites. Here, one of GNSS signals received by the vehicles 10 is referred to as a first GNSS signal. When the vehicle 10 is traveling, the vehicle 10 travels for a certain period of time, moves a predetermined distance, and then receives GNSS signal. GNSS signal received at this time is referred to as a second GNSS signal. In addition, the vehicle 10 acquires information indicating the traveling state of the vehicle 10 such as the vehicle speed and the travel direction (travel information) while the vehicle is traveling. The vehicle 10 transmits the first GNSS signal, the second GNSS signal, and the travel information to the in-vehicle device 100.

When it is determined that the vehicle 10 is traveling, the in-vehicle device 100 determines whether the location calculated based on the second GNSS signal has changed from the location calculated based on the first GNSS signal. When the in-vehicle device 100 determines that the location calculated based on the second GNSS signal has changed from the location calculated based on the first GNSS signal, the in-vehicle device 100 performs the following process (FIG. 1A).

The in-vehicle device 100 determines whether the difference between the location of the vehicle 10 estimated based on the first GNSS signal received before the second GNSS signal and the travel information of the vehicle 10 and the location calculated based on the second GNSS signal is within a predetermined range. For example, the in-vehicle device 100 estimates, based on the travel information of the vehicle 10, the distance and direction in which the vehicle 10 has traveled from the time when the first GNSS signal is received to the time when the second GNSS signal is received. The in-vehicle device 100 may use the estimated distance and direction as the difference from the location calculated based on the first GNSS signal, and localize the vehicle 10 at the time the second GNSS signal is received, by using this difference.

Then, when the difference between the location estimated based on the first GNSS signal and the travel information of the vehicle 10 and the location calculated based on the second GNSS signal is within a predetermined range, the in-vehicle device 100 estimates the location calculated based on the second GNSS signal as the location of the vehicle 10. Even when the vehicle 10 is not traveling, when the difference between the location estimated based on the first GNSS signal and the travel information of the vehicle 10 and the location calculated based on the second GNSS signal is within a predetermined range, the location calculated based on the second GNSS signal is estimated as the location of the vehicle 10.

On the other hand, the in-vehicle device 100 estimates the location estimated based on the first GNSS signal and the travel information of the vehicle 10 as the location of the vehicle 10 when the difference between the location estimated based on the first GNSS signal and the travel information of the vehicle 10 and the location calculated based on the second GNSS signal is not within a predetermined range.

When the in-vehicle device 100 determines that the vehicle 10 is traveling and the in-vehicle device 100 determines that the location calculated based on the second GNSS signal has not changed from the location calculated based on the first GNSS signal, the in-vehicle device 100 performs the following process (FIG. 1B).

The in-vehicle device 100 estimates the location estimated based on the first GNSS signal and the travel information of the vehicle 10 as the location of the vehicle 10. When the vehicle 10 is not traveling, the in-vehicle device 100 does not update the location of the vehicle 10.

As described above, the in-vehicle device 100 independently localizes the vehicle 10 at the time when the second GNSS signal is received by estimating the difference from the location calculated based on the first GNSS signal etc. received in advance by using the vehicle speed etc. of the vehicle 10. Then, the in-vehicle device 100 determines the reliability of the second GNSS signal by comparing the independently estimated location of the vehicle 10 with the location calculated based on the second GNSS signal, and selects a method for localizing the vehicle 10 according to the reliability of the second GNSS signal. That is, the in-vehicle device 100 localizes the vehicle 10 based on the GNSS signal only when it is determined that the highly reliable GNSS signal has been received. Accordingly, the in-vehicle device 100 can use a GNSS signal only when the reliability of the GNSS signal received by the vehicle 10 is high, and can select a localizing method in which the influence of the GNSS signal is eliminated when the reliability of the GNSS signal is low.

According to this configuration, the in-vehicle device 100 can appropriately select a method for localizing the vehicle 10 based on the reliability of the received GNSS signal.

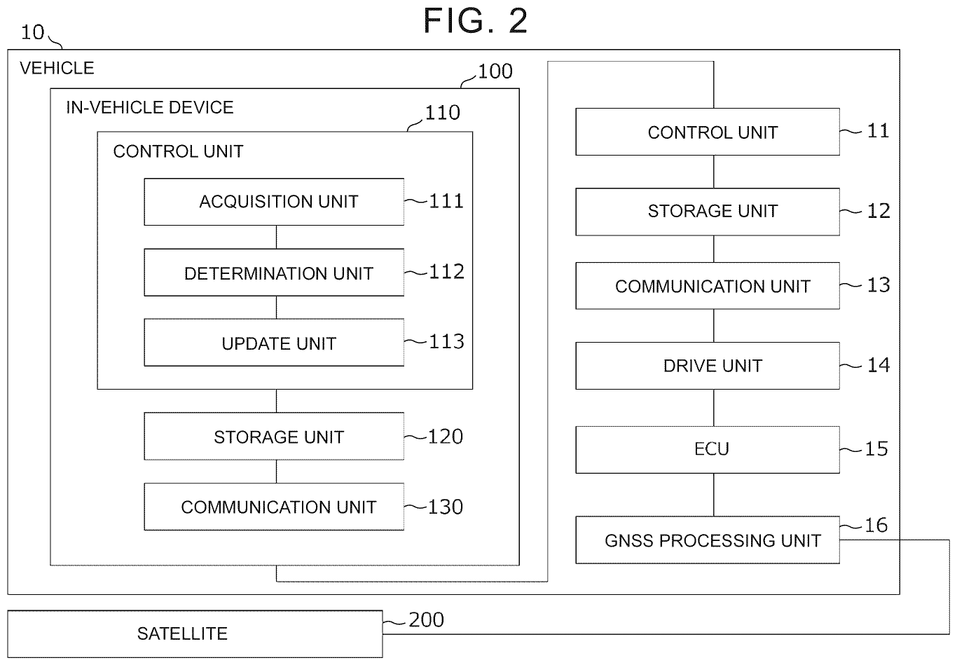

Next, each element constituting the system will be described in detail. FIG. 2 is a diagram illustrating components of the system according to the embodiment. The system includes an in-vehicle device 100, a satellite 200, and a vehicle 10.

The in-vehicle device 100 according to the present embodiment includes a control unit 110, a storage unit 120, and a communication unit 130.

The control unit 110 is implemented by a processor such as a CPU (Central Processing Unit) or a GPU (Graphics Processing Unit) and a memory. The control unit 110 includes an acquisition unit 111, a determination unit 112, and an update unit 113 as functional modules. These functional modules may be realized by executing a program by the control unit 110.

The acquisition unit 111 acquires GNSS received by the vehicle 10 from the satellites 200 from the vehicle 10. Specifically, the first GNSS signal and the second GNSS signal received after the first GNSS signal among GNSS signals periodically received by the vehicles 10 from the satellites 200 are received.

Further, the acquisition unit 111 acquires information indicating the traveling state of the vehicle 10 (travel information) from the vehicle 10. The travel information of the vehicle 10 includes a vehicle speed, a travel direction, time information, and the like of the vehicle 10.

The determination unit 112 determines whether the vehicle 10 is in the traveling state. The determination unit 112 may determine whether the vehicle 10 was in the traveling state between the time when the first GNSS signal is received and the time when the second GNSS signal is received. The determination unit 112 may determine whether the vehicle 10 is in the traveling state based on the vehicle speed of the vehicle 10 or the like.

The determination unit 112 determines whether the location calculated based on the second GNSS signal has changed from the location calculated based on the first GNSS signal.

The determination unit 112 calculates a difference from the location calculated based on the first GNSS signal from the vehicle speed etc. of the vehicle 10. Then, it may be determined whether the difference between the location of the vehicle 10 at the time when the second GNSS signal calculated by the above method is received and the location calculated based on the second GNSS signal is within a predetermined range. When calculating the location of the vehicle 10 at the time when the second GNSS signal is received, the determination unit 112 may use the location indicated by the beacon signal emitted from the device installed at the predetermined place instead of the location calculated based on the first GNSS signal.

The update unit 113 selects the methods to be used for localizing the vehicle 10 based on whether the location of the vehicle 10 at the time when the second GNSS signal is received, which is estimated from the vehicle speed etc. of the vehicle 10, matches the location calculated based on the second GNSS signal. Specifically, when the difference between the location of the vehicle 10 at the time point when the second GNSS signal is received and the location calculated based on the second GNSS signal estimated from the vehicle speed etc. of the vehicle 10 is within a predetermined range, the update unit 113 may localize the vehicle 10 based on the second GNSS signal. When the difference between the location of the vehicle 10 at the time point when the second GNSS signal is received and the location calculated based on the second GNSS signal estimated from the vehicle speed etc. of the vehicle 10 is not within a predetermined range, the update unit 113 may localize the vehicle 10 based on the travel information of the vehicle 10.

The storage unit 120 is an auxiliary storage device such as a main storage device such as a RAM or a ROM, a EPROM, a hard disk drive, and a removable medium. The secondary storage device stores an operating system (OS), various programs, various tables, and the like, and by executing the programs stored therein, it is possible to realize the respective functions matching the predetermined objectives of the respective units of the control unit 110. However, some or all of the functions may be implemented by a hardware circuit such as an ASIC or an FPGA.

The storage unit 120 stores data or the like used or generated in processing performed by the control unit 110. Further, the storage unit 120 may store road map information and the like.

The communication unit 130 includes a communication circuit that performs wireless communication. The communication unit 130 may be, for example, a communication circuit that performs wireless communication using 4G (4th Generation) or a communication circuit that performs wireless communication using 5G (5th Generation). The communication unit 130 may be a communication circuit that performs radio communication using LTE (Long Term Evolution) or a communication circuit that performs communication using LPWA (Low Power Wide Area). Further, the communication unit 130 may be a communication circuit that performs radio communication using Wi-Fi (registered trademark).

Next, a device other than the in-vehicle device 100 will be described. The satellite 200 is a satellite used in a satellite positioning system. The satellite 200 may be a plurality of GPS satellites or quasi-zenith satellites. The satellites 200 transmit GNSS to a terrestrial receiver. The receiver identifies its location based on the velocity of the radio waves of GNSS signals received from the plurality of satellites 200 and the propagation times of the radio waves. In the present application, the satellites 200 transmit GNSS to GNSS processor 16 of the vehicles 10.

The vehicle 10 is a vehicle such as a passenger car. The vehicle 10 may be a truck, a bus, or the like. The vehicle 10 includes a control unit 11, a storage unit 12, a communication unit 13, a drive unit 14, an ECU 15, and a GNSS processor 16. Vehicles 10 periodically receive GNSS from satellites 200. Further, the vehicle 10 may communicate with the in-vehicle device 100 and receive the location of the vehicle 10 etc. estimated by the in-vehicle device 100.

The control unit 11 controls ECU (Electronic Control Unit) and the like mounted on the vehicles 10. The control unit 11 is implemented by a processor such as a CPU or a GPU and memories. The control unit 11 may control the storage unit 12, the communication unit 13, the drive unit 14, ECU 15, and GNSS processor 16 by executing a program.

The storage unit 12 is an auxiliary storage device such as a main storage device such as a RAM or a ROM, a EPROM, a hard disk drive, and a removable medium. The secondary storage device stores an operating system (OS), various programs, various tables, and the like, and by executing the programs stored therein, it is possible to realize the respective functions matching the predetermined objectives of the respective units of the control unit 11. However, some or all of the functions may be implemented by a hardware circuit such as an ASIC or an FPGA.

The storage unit 12 stores data or the like used or generated in the processing performed by the control unit 11. The storage unit 12 may store road map information and the like.

The communication unit 13 includes a communication circuit that performs wireless communication. The communication unit 13 may be, for example, a communication circuit that performs wireless communication using a 4G or a communication circuit that performs wireless communication using a 5G. The communication unit 13 may be a communication circuit that performs radio communication using an LTE, or may be a communication circuit that performs communication using a LPWA. Further, the communication unit 13 may be a communication circuit that performs radio communication using Wi-Fi (registered trademark).

The drive unit 14 is a means for causing the vehicle 10 to travel. The drive unit 14 may include, for example, a motor, an inverter, a brake, and a steering mechanism for driving wheels. The drive unit 14 may be operated by electric power supplied from a battery.

ECU 15 is an electronic control unit that is a computer for realizing various functions required for traveling of the vehicles 10. A plurality of ECU 15 may be mounted. ECU 15 acquires or generates various kinds of information included in the traveling information of the vehicle 10, and transmits the various kinds of information to the in-vehicle device 100. For example, ECU 15 acquires travel information such as the vehicle speed and the traveling direction of the vehicle 10, and transmits the travel information to the in-vehicle device 100.

GNSS processor 16 includes an antenna for receiving a GNSS signal and a processor for processing the received GNSS signal. GNSS processor 16 periodically receives GNSS from the satellites 200, calculates location information, and transmits the location information to the in-vehicle device 100.

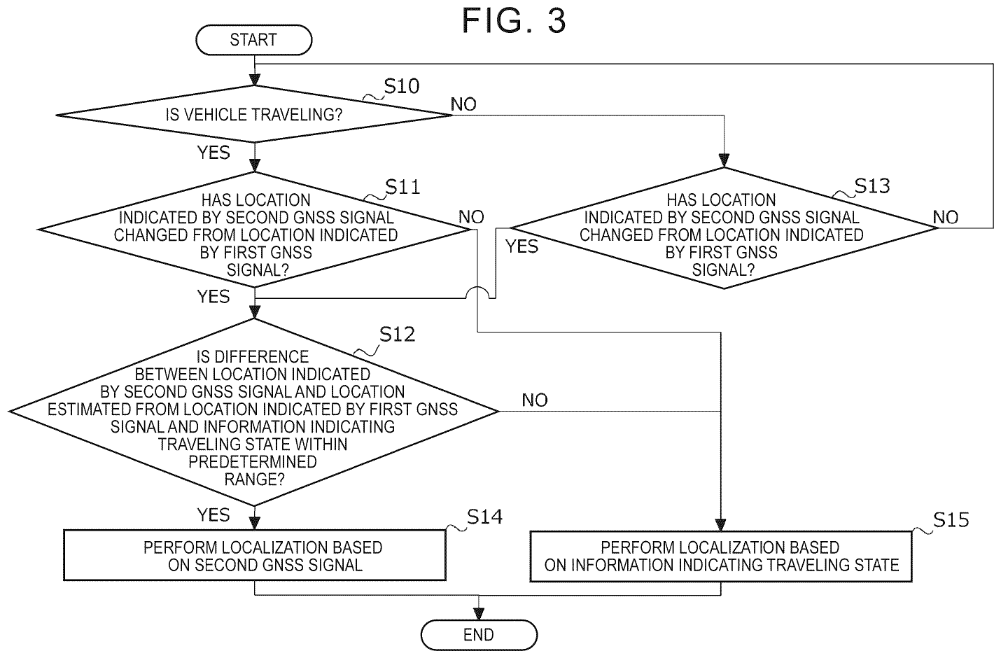

Next, specific contents of processing performed by the in-vehicle device 100 will be described. FIG. 3 is a flowchart of processing executed by the control unit 110 of the in-vehicle device 100 according to the embodiment.

For example, the in-vehicle device 100 may start the processing illustrated in FIG. 3 when the ignition switch of the vehicle 10 is turned on. It is assumed that the in-vehicle device 100 has already received the first GNSS signal and the second GNSS signal from the satellites 200 prior to starting the process illustrated in FIG. 3.

First, in S10, the determination unit 112 determines whether the vehicle 10 is traveling. Specifically, the determination unit 112 determines whether the vehicle 10 is traveling based on the travel information acquired by the acquisition unit 111. For example, when the vehicle speed of the vehicle 10 acquired by the acquisition unit 111 is equal to or greater than a predetermined value, the determination unit 112 may determine that the vehicle 10 is traveling.

When the determination unit 112 determines that the vehicle 10 is traveling, this step is an affirmative determination.

If an affirmative determination is made in this step, the process proceeds to S11.

If a negative determination is made in this step, the process proceeds to S13.

Next, in S11, the determination unit 112 determines whether the location calculated based on the second GNSS signal has changed from the location calculated based on the first GNSS signal. When the determination unit 112 determines that the location calculated based on the second GNSS signal has changed from the location calculated based on the first GNSS signal, the determination in this step is affirmative.

If an affirmative determination is made in this step, the process proceeds to S12.

If a negative determination is made in this step, the process proceeds to S15.

When the process transitions to S13, similarly to S11, the determination unit 112 determines whether the location calculated based on the second GNSS signal has changed from the location calculated based on the first GNSS signal. When the determination unit 112 determines that the location calculated based on the second GNSS signal has changed from the location calculated based on the first GNSS signal, the determination in this step is affirmative.

If an affirmative determination is made in this step, the process proceeds to S12.

If a negative determination is made in this step, the process proceeds to S10.

Next, in S12, the determination unit 112 determines whether the difference between the location of the vehicle 10 at the time the second GNSS signal is received and the location calculated based on the second GNSS signal, which is estimated from the location of the vehicle 10 and the travel information acquired in advance, is within a predetermined range.

Specifically, the determination unit 112 calculates a distance and a direction advanced from the location calculated based on the first GNSS signal based on the vehicle speed, the traveling direction, and the like of the vehicle 10, and calculates a difference from the location calculated based on the first GNSS signal to the location of the vehicle 10 when the second GNSS signal is received. Here, the difference is a direction and a distance from a location of the vehicle 10 when the second GNSS signal is received to a location calculated based on the first GNSS signal. At this time, the determination unit 112 calculates the distance and the direction advanced from the location calculated based on the first GNSS signal based on the vehicle speed, the traveling direction, and the like of the vehicle 10. Thus, the determination unit 112 may calculate a difference from the location calculated based on the first GNSS signal to the location of the vehicle 10 when the second GNSS signal is received.

Note that, instead of the first GNSS signal, the determination unit 112 may receive a beacon signal emitted by a device installed at a predetermined location, and calculate, as a difference, a distance and a direction advanced from a location indicated by the beacon signal. For example, the beacon signal may be emitted from a roadside device installed on a road.

Then, the determination unit 112 estimates the location advanced by the difference from the location calculated based on the first GNSS signal as the location of the vehicle 10 at the time when the second GNSS signal is received. Then, the determination unit 112 compares the estimated location with the location calculated based on the second GNSS signal, and determines whether the difference between these locations is within a predetermined range.

When the determination unit 112 determines that the difference between the location of the vehicle 10 at the time the second GNSS signal estimated based on the difference from the location calculated based on the first GNSS signal estimated from the vehicle speed etc. of the vehicle 10 is received and the location calculated based on the second GNSS signal is within a predetermined range, the present step is an affirmative determination.

If an affirmative determination is made in this step, the process proceeds to S14.

If a negative determination is made in this step, the process proceeds to S15.

When the process transitions to S14, the update unit 113 localizes the vehicle 10 based on the second GNSS signal. In other words, the update unit 113 selects to update the location information of the vehicle 10 using the location calculated based on the second GNSS signal as the location of the vehicle 10.

When the process transitions to S15, the update unit 113 estimates the location of the vehicle 10 based on the location of the vehicle 10 and the travel information acquired in advance. That is, the update unit 113 selects to update the location information of the vehicle 10 using the location obtained by adding the difference, which is the direction and the distance that the vehicle 10 has traveled from the location of the vehicle 10 acquired in advance, to the location of the vehicle 10 acquired in advance as the location of the vehicle 10. The update unit 113 may calculate the distance traveled by the vehicle 10 from the location of the vehicle 10 acquired in advance based on the travel information.

Thus, the in-vehicle device 100 can determine the level of reliability of the GNSS signal, and can select to localize the vehicle 10 using the GNSS signal only when a highly reliable GNSS signal is received. When the in-vehicle device 100 cannot receive the highly reliable GNSS signal, it can select to localize the vehicle 10 using the location of the vehicle 10 and the travel information acquired in advance. Therefore, the in-vehicle device 100 can appropriately switch the methods of localizing the vehicle 10 according to the reliability of the received GNSS signal.

### Modified Examples

The above-described embodiment is merely an example, and the present disclosure may be appropriately modified and implemented without departing from the scope thereof.

For example, the processes and means described in the present disclosure can be freely combined and implemented as long as no technical contradiction occurs.

Further, the processes described as being executed by one device may be shared and executed by a plurality of devices. Alternatively, the processes described as being executed by different devices may be executed by one device. In the computer system, it is possible to flexibly change the hardware configuration (server configuration) for realizing each function.

The present disclosure can also be implemented by supplying a computer with a computer program that implements the functions described in the above embodiment, and causing one or more processors of the computer to read and execute the program. Such a computer program may be provided to the computer by a non-transitory computer-readable storage medium connectable to the system bus of the computer, or may be provided to the computer via a network. The non-transitory computer-readable storage medium is, for example, a disc of any type such as a magnetic disc (floppy (registered trademark) disc, hard disk drive (HDD), etc.), an optical disc (compact disc (CD)-read-only memory (ROM), digital versatile disc (DVD), Blu-ray disc, etc.), a ROM, a random access memory (RAM), an erasable programmable read only memory (EPROM), an electrically erasable programmable read only memory (EEPROM), a magnetic card, a flash memory, an optical card, and any type of medium suitable for storing electronic commands.

What is claimed is:

1. An information processing device comprising a control unit, the control unit being configured to
localize a vehicle,
receive a global navigation satellite system (GNSS) signal,
acquire information indicating a traveling state of the vehicle, and
determine whether to localize the vehicle based on the GNSS signal or to localize the vehicle based on the information indicating the traveling state of the vehicle, based on whether a first location and a second location match, the first location being a location of the vehicle estimated from previously acquired location information of the vehicle and the information indicating the traveling state of the vehicle, and the second location being a location of the vehicle calculated based on the GNSS signal.

2. The information processing device according to claim 1, wherein the control unit is configured to when a difference between the first location and the second location is within a predetermined range, localize the vehicle based on the GNSS signal.

3. The information processing device according to claim 1, wherein the control unit is configured to when the vehicle is determined to be traveling and the location of the vehicle calculated based on the GNSS signal is determined not to have changed, localize the vehicle based on the information indicating the traveling state of the vehicle.

4. The information processing device according to claim 1, wherein the control unit is configured to when the vehicle is determined not to be traveling and the location of the vehicle calculated based on the GNSS signal is determined not to have changed, not localize the vehicle.

5. An information processing method comprising:
localizing a vehicle;
receiving a global navigation satellite system (GNSS) signal;
acquiring information indicating a traveling state of the vehicle; and
determining whether to localize the vehicle based on the GNSS signal or to localize the vehicle based on the information indicating the traveling state of the vehicle, based on whether a first location and a second location match, the first location being a location of the vehicle estimated from previously acquired location information of the vehicle and the information indicating the traveling state of the vehicle, and the second location being a location of the vehicle calculated based on the GNSS signal.
